(19) United States
(12) Patent Application Publication
(10) Pub. No.: US 2010/0020913 A1
(43) Pub. Date: Jan. 28, 2010

(54) Method for obtainging plasma

(76) Inventor: Alexander Mozgovoy, Moscow (RU)

Correspondence Address: Mozgovoy Alexander, otkrytoe shosse 6-11-5, Moscow, 107370, RU

(21) Appl. No.: 11/754,324

(22) Filed: Jul. 22, 2008

(51) Int. Cl. G21B 1/05

(52) U.S. Cl. 376/133

(57) ABSTRACT

A method for obtaining high temperature plasma in the Field Reversed Configuration (FRC) magnetic topology is described, allowing for compression, retention and heating plasma, which can be used for obtaining thermonuclear energy or laser pumping. The storage of the magnetic field energy is accomplished by creating a current in the winding of a solenoid over a working volume. In addition, a pulse toroidal magnetic field with force lines perpendicular to the magnetic field of the solenoid is created via the transmission of a current through the working volume. Then, the current is broken off in the solenoid winding when it reaches its maximum to excite a closed current loop in the plasma created in the working volume. The change of the direction of magnetic field outside the current-carrying loop in the plasma is achieved either by changing to the opposite direction of the current in the solenoid or transmitting the current in additional turns parallel to the turns of the solenoid.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

1. Field of the Invention

The invention relates to the field of plasma physics and can be used for compression, retention, and heating plasma and for obtaining thermonuclear energy.

2. Description of the Related Art

Obtaining hot plasma is normally achieved by exciting current in the plasma via a change of magnetic flux, for example, ohmical heating in tokamaks. In the method of heating plasma with Field Reversed Configuration (FRC), a rapid discharge of batteries to the winding (turn) is used. The solenoid winding is arranged so that it covers the chamber with the working gas, which is being ionized, forming a closed current-carrying loop, compressed to the center of the chamber.

There is also a method of plasma excitation with inductor located outside the plasma described in U.S. Pat. No. 6,891,911, issued to Rostoker et al. Similar excitation of plasma takes place in the spherical tokamaks. In all these cases, energy to the plasma is topologically supplied from external sources and, as shown by experiments, there is no success so far in attaining effective energy transfer from sources to the plasma. Efficiency is always small. Furthermore, in all these plasma configurations there is no internal mechanism leading to self-heating of the plasma.

This internal mechanism, based on longitudinal compression (pinching) of the current-carrying loop, is possible only in a compact torus. An additional condition is changing (reversing) the direction of the current in the excitation winding. Reversing is also a necessary condition to prevent expansion of the current-carrying loop in the radial direction. Pinching of a wide current turn follows from the fundamental laws of Ampere about the attraction of unidirectional currents (a wide current turn can be considered as a set of rings carrying currents of the same direction). During pinching, the magnetic energy stored in the turn is utilized for heating plasma. Thanks to this unique property of the compact torus, several decades of experimentation were spent in search of an effective generation of such torus. However, the results were far below expectations—only a few percent of the input energy was transferred from the source into the compact torus.

The closest to the proposed method is the method of obtaining high-temperature plasma described in the patent of the Russian Federation No. 2,082,289. In this patent, excitation of the eddy current is performed by using an inductive accumulator, which is also used for preliminarily accumulation of magnetic energy in the working region. Ionization is accomplished by interrupting current flowing through the accumulator. This technique has the same drawback: low coefficient of capturing magnetic flux.

There is still a need to increase the efficiency of the conversion of the stored energy of magnetic field into the energy of plasma, as well as effective compression and retention of the plasma that, eventually, might lead to the conditions sufficient for the reactions of thermonuclear fusion with positive energy production.

### BRIEF SUMMARY OF THE INVENTION

The present invention is a method for obtaining high temperature plasma in the FRC magnetic topology, allowing for compression, retention and heating plasma. It can be used for obtaining thermonuclear energy or laser pumping.

The storage of the magnetic field energy is accomplished by creating a current in the winding solenoid, covering a working volume. A pulse toroidal magnetic field with force lines perpendicular to the magnetic field of the solenoid is created via the transmission of a current through the working volume. The current is interrupted in the solenoid winding when it reaches its maximum to excite a closed current loop in the plasma. The change of direction of the magnetic field outside the current-carrying loop in the plasma is achieved either by changing to the opposite direction of the current in the solenoid or feeding of the current in an additional turns, parallel to the turns of the solenoid.

### BRIEF DESCRIPTION OF THE DRAWINGS

The present invention is best understood with reference to the attached drawings in which like numerals refer to like elements, and in which:

FIG. 1 shows a system with Field Reversed Configuration;

FIG. 2 shows photo of the experimental setup

FIG. 3 shows an electro-physical schematic of the system used in the experiments:

FIG. 4 shows placement of magnetic field sensors in and outside the chamber;

FIG. 5 shows typical oscillograms, corresponding to the case when the compression winding was not fed;

FIG. 6 shows typical oscillograms when the compression winding is turned on in 3 μs after the current break in the solenoid;

### DESCRIPTION OF PREFERRED EMBODIMENT

In the most general terms, the invention represents a method for obtaining high temperature plasma in the Field Reversed Configuration (FRC) magnetic topology, allowing for compression, retention and heating plasma.

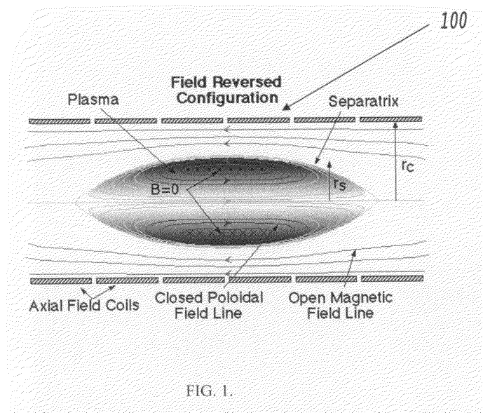

FIG. 1 shows the magnetic field of an FRC. An FRC is formed in cylindrical coil 100 of radius r_{c}, which produces an axial magnetic field. There is a region of closed poloidal field lines where magnetic field is zero or at least relatively small. There is also a region with open magnetic field lines where magnetic field is substantially not equal to zero. In the center of the solenoid, the direction of the magnetic field is opposite to the direction of the magnetic field outside the region of closed poloidal field lines. Separatrix is the surface with characteristic radius rₛ which separates a region with closed field lines from the region with open magnetic field lines.

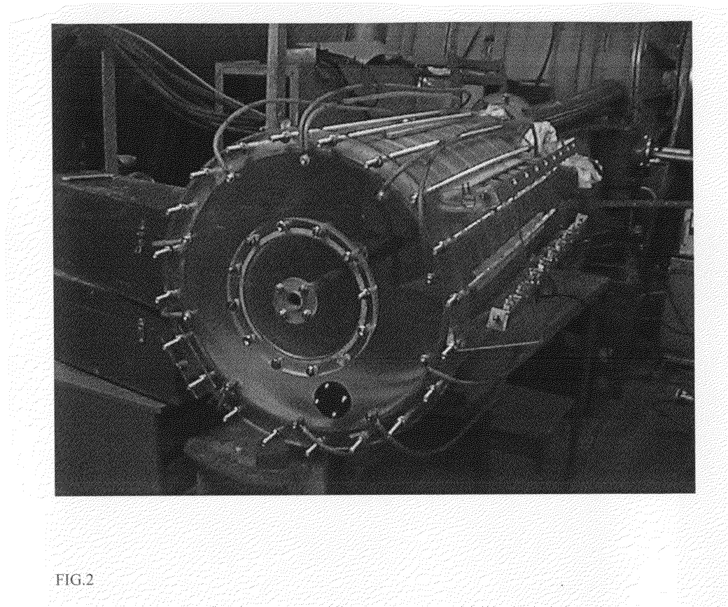

The general view of the system illustrating the invention is presented in FIG. 2, where one can see the experimental setup for creating the FRC.

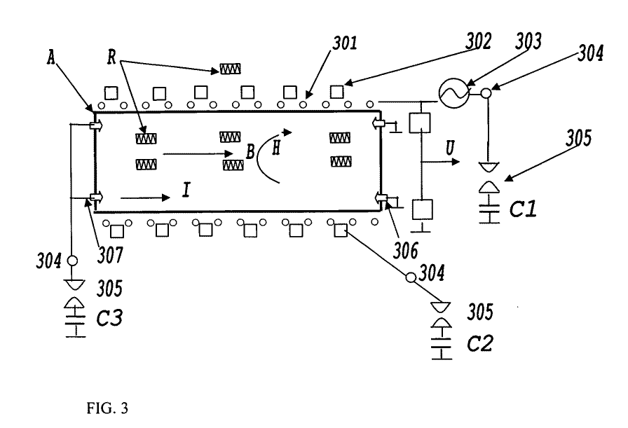

The electro-physical schematic of the system used in the experiments described below is presented in FIG. 3, where
301—solenoid winding turns of inductive energy store;
302—compression winding turns;
303—interrupter of current;
304—Rogovski's belts;
305—dischargers;
306—ground electrodes to collect the longitudinal current;
307—high-voltage electrodes to initiate longitudinal current;
C1—capacitor battery of inductive energy store;
C2—capacitor battery of compression winding;
C3—capacitor battery used for excitation of longitudinal current as well as toroidal field;
A—working chamber;
U—voltage divider;
R—sensor of magnetic field;
B—magnetic field of solenoid;
H—force lines of toroidal magnetic field;
I—current in the plasma in the longitudinal direction;

In the experiments we used an 850 mm long chamber with a diameter of 500 mm made of composite dielectric. The end transparent flanges are made of Plexiglas. Two windings are placed on the chamber—the storage multi-start winding (total—49 turns) and a compression multi-start winding (total—48 turns). The windings connected in opposite directions. The voltage is applied to 10 electrodes placed on the flanges using cables to excite a longitudinal current and create a toroidal field in the chamber. The return current cables are placed longitudinally outside the chamber.

Three independent capacitor batteries are used in the experiment. The first battery, C1, is used to feed the storage solenoid through the current breaker in the form of an exploding wire. The second battery C2 is used to feed the compression winding and the third battery, C3, is used for excitation of longitudinal current as well as for excitation of the toroidal field.

In our experiment the energy stored in the capacitor C1 is transferred into the solenoid winding (301). The energy of magnetic field B is stored in winding 301, which covers the working volume A. When current in the solenoid winding reaches its maximum the whole energy is accumulated in the magnetic field and at this moment the current interrupter is switched off. This leads to change of magnetic flux through the plasma, and eventually, induces current in the plasma.

Both the electrical breakdown of working gas along the dielectric surface of the working volume (from high voltage electrodes 307 to the ground electrodes 306) and injection of plasma into the working volume can be used to create the plasma.

An additional toroidal magnetic field H is created by exciting longitudinal current from the capacitor battery C3. By analogy with the magnetic fields of tokamak we name this field a toroidal field, since its force lines are closed and located inside the working volume. The force lines of a pulse toroidal magnetic field H are perpendicular to the magnetic field B of the solenoid. The total force line of the magnetic field has a shape of a helix.

To induce a current in the plasma the current in the solenoid is cut off by interrupter 303 when it reaches its maximum. Since the magnetic field of the induced current is trying to maintain the magnetic flux of the solenoid, the induced current in the plasma has the same direction as the current in the solenoid. Like in the usual transformer, the current can be kN times stronger than the current in the solenoid, where N is the number of turns in the solenoid, and k is some conditional coupling coefficient between the turns of the solenoid and the current-carrying loop in the plasma.

Since the electrons, being the main carriers of the current in the plasma, move against the magnetic force lines of the solenoid, the magnetic field of the solenoid prevents inducing a current in the plasma. That is why the additional toroidal magnetic field H helps to increase the current in the plasma to a maintainable level of the original magnetic field (in our experiments the achieved level of the plasma magnetic field was 70% of the primary field).

Then after current in the solenoid winding is broken off; the direction of the magnetic field outside the formed current-carrying loop in the plasma is changed to the opposite direction to guarantee compression, retention and heating plasma

A change of the direction of the magnetic field is performed by inducing current of the right direction in the compression winding (302).

It's also may be done by inducing current of opposite direction in the solenoid (301).

Next we describe our experimental results that clearly illustrate how the invention permits compression of the plasma in both radial and longitudinal direction with formation of FRC.

Three blocks of condensers C1, C2, C3 of 80 μF total capacitance were used in the experiments. Special attention was paid to select the vacuum switches that tolerate a high voltage (up to 200 kV) arising during current cut-off in the solenoid and work in the broad range of the control ignition. The first block of condensers C1 of 20 μF was used to feed the storage solenoid through the current breaker (an exploding wire). The second block C2 of 40 μF was used to create a toroidal magnetic field in the chamber. This block was connected to the system before the current break in the solenoid. The moment when a toroidal field reaches its maximum coincides with the moment when beginning of the current break takes place. The same current was used to create pre-ionization of plasma in the chamber.

The third block C3 of 20 μF was used to create a magnetic field contracting the plasma to the center of the chamber and it was connected to the system after the current break in the solenoid.

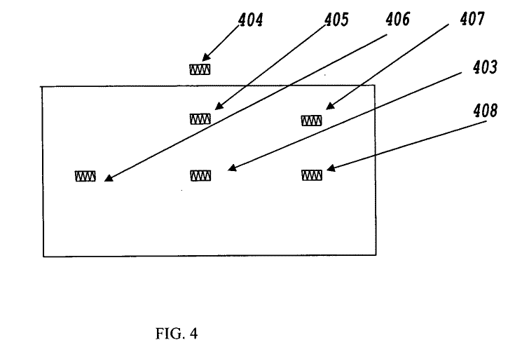

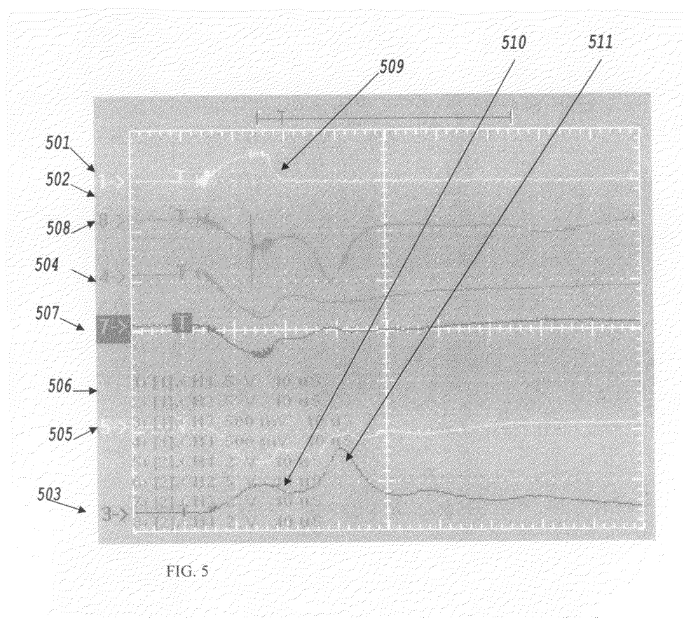

Five magnetic field sensors 403, 405, 406, 407, 408 were placed directly in the chamber and one sensor 404 was placed outside the chamber as shown in FIG. 4. The typical oscillograms, corresponding to the case when compression winding was not fed, are presented in FIG. 5 where
501—current in the solenoid;
502—current in the plasma to create a toroidal magnetic field;
503—magnetic field at the center of the chamber;
504—magnetic field outside the chamber;
505—magnetic field at radius 20 cm to the right;
506—magnetic field at the center to the left;
507—magnetic field at radius 20 cm in the center;
508—magnetic field at the center to the right;
509—zero level of the current in solenoid after cut off;
510—captured level of magnetic field;
511—compression of the magnetic field;

From the diagrams in FIG. 5, we see how current cut-off in the solenoid leads to the reduction of magnetic field in the center of the chamber to approximately 70% of initial level of magnetic field (510). From the moment 509, corresponding to zero level of the current in the solenoid, the magnetic field is maintained by a current loop in the plasma. Compression of magnetic field 511 is detected by the sensor 503 placed in the center of the chamber.

The level of captured magnetic flux is controlled by the toroidal magnetic field produced by the longitudinal current 502.

Next figure illustrates the effect of compression winding being on.

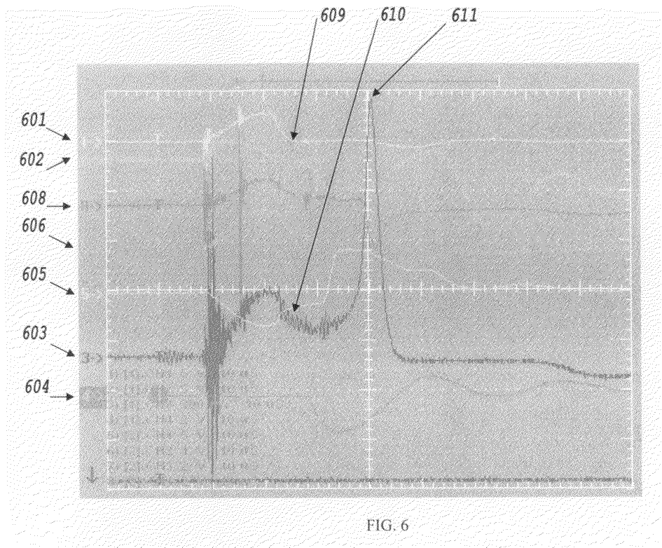

Typical oscillograms when compression winding is turned on in 3 μs after the current break in the solenoid are presented in FIG. 6.

Notation in FIG. 6:
601—current in the solenoid;
602—voltage on exploding wire;
603—sensor of magnetic field at the center of the chamber;
604—current in the compression winding;
605—magnetic field at radius 20 cm in the center;
606—magnetic field at center to the left;
608—magnetic field at center to the right;
609—zero level of the solenoid current;
610—captured level of magnetic field;
611—compression of the magnetic field;

From FIG. 6 we can clearly see how the current in the compression winding leads to the sign reversal in all the sensors except the central one, where we observe an increase of magnetic field. This undoubtedly indicates compression of the formed current-carrying loop in both radial and longitudinal directions and formation of FRC.

In summary, the following sequence outlines the main steps of the invention:
a) Magnetic field energy is accumulated in the solenoid which is fed by the supplied current.
b) Plasma is created in the working volume of the solenoid before current in the solenoid reaches maximum.
c) Toroidal (circular) magnetic field is created, which in combination with the magnetic field of the solenoid forms the net magnetic field. The magnetic lines of this net field have a helical form.
d) The current in the solenoid is cut off to induce a current in the plasma. Since the magnetic field of the induced current is trying to maintain the magnetic flux of the solenoid, the induced current in the plasma has the same direction as the current in the solenoid.
e) After the current in the solenoid is cut off, the direction of the magnetic field outside the formed current-carrying loop in the plasma is changed to the opposite direction to compress the compact torus in the radial direction.

What is claimed is:

1. A method of obtaining a high temperature plasma, comprising the steps of
a) storing the magnetic field energy in the solenoid winding;
b) creating plasma in the working volume;
c) creating a pulse toroidal magnetic field with the force lines perpendicular to the magnetic field of the solenoid;
d) breaking off the current in the solenoid winding when it reaches its maximum to excite a closed current loop in the plasma;
e) compressing plasma in the radial direction by changing to the opposite direction of the magnetic field outside the current-carrying loop in the plasma after current in the solenoid winding is broken off;

2. The method of claim 1 with the winding solenoid, covering a working volume.

3. (canceled)

4. The method of claim 1 with a pulse toroidal magnetic field created via transmission of a current through the working volume in the longitudinal direction.

5. (canceled)

6. The method of claim 1 when the change of the direction of the magnetic field outside the current-carrying loop in the plasma is achieved by feeding current in at least one auxiliary turn, parallel to the turns of the solenoid after current in the solenoid winding is broken off.
